(19) United States
(12) Patent Application Publication
(10) Pub. No.: US 2014/0122267 A1
(43) Pub. Date: May 1, 2014

(54) DIGITAL CARD DEVICE AND METHOD

(71) Applicant: Ray Tayebi, Anaheim Hills, CA (US)

(72) Inventor: Ray Tayebi, Anaheim Hills, CA (US)

(21) Appl. No.: 13/804,018

(22) Filed: Mar. 14, 2013

Related U.S. Application Data
(60) Provisional application No. 61/718,932, filed on Oct. 26, 2012.

(51) Int. Cl. G06Q 20/36

(52) U.S. Cl. CPC G06Q 20/3674
USPC 705/17; 705/41

(57) ABSTRACT

A mobile device configured to replace physical card(s) of a user, the mobile device being capable of performing a process including in any order the steps of: receiving from the card issuer card data necessary for performing cardless transactions; storing the card data; receiving from the user instructions for initiating a cardless transaction; authenticating the user before the cardless transaction is initiated; and, initiating the cardless transaction by transmitting the card data to a card data reader.

### CROSS-REFERENCE TO RELATED APPLICATIONS

This application claims the benefit of U.S. Provisional Application No. 61/718,932, filed Oct. 26, 2012, which is hereby incorporated by reference, to the extent that it is not conflicting with the present application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The invention relates generally to card based transactions and more particularly to an apparatus, system and method for replacing physical cards with digital cards.

2. Description of the Related Art

Today, most people carry with them in their wallet or purse several cards such as ATM cards, credit cards, driver license, building access cards and so on. They use the cards at grocery stores, gas stations, banks, government agencies, workplace, and so on. One problem is that the cards are too many. Another problem is that the cards can be easily lost or stolen. Thus, there is a need for an apparatus that can replace all cards, and which is more secure and convenient to use.

### BRIEF SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In one exemplary embodiment a digital card app is installed into a smartphone such that the smartphone may receive data associated with several cards form the cards' issuers, store the data and, after authenticating the user, transmit it securely to a card reader in order to perform a cardless transaction, such a payment for groceries at a grocery store. Thus, an advantage is that people will not need to carry with them and use plastic cards that can be easily lost or stolen. Another advantage is that issuers of the cards will not need to spend resources with the manufacturing of plastic cards.

The above embodiment and advantages, as well as other embodiments and advantages, will become apparent from the ensuing description and accompanying drawings.

### BRIEF DESCRIPTION OF THE DRAWINGS

For exemplification purposes, and not for limitation purposes, embodiments of the invention are illustrated in the figures of the accompanying drawings, in which:

FIG. 1 is a schematic view of an exemplary digital card device, according to an embodiment.

FIG. 2 is a schematic view of an exemplary system incorporating the digital card device from FIG. 1, according to several embodiments.

FIG. 3 is a schematic view of an alternative exemplary system incorporating a mobile device 350 adapted to function as a digital card device, according to several embodiments.

### DETAILED DESCRIPTION OF THE PREFERRED EMBODIMENTS

What follows is a detailed description of the preferred embodiments of the invention in which the invention may be practiced. Reference will be made to the attached drawings, and the information included in the drawings is part of this detailed description. The specific preferred embodiments of the invention, which will be described herein, are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

As used herein and throughout this disclosure, the term “mobile device” refers to any electronic device capable of communicating across a mobile network. A mobile device may have a processor, a memory, a transceiver, an input, and an output. Examples of such devices include cellular telephones, smartphones, personal digital assistants (PDAs), portable computers, tablet computers, etc. The memory stores applications, software, or logic. Examples of processors are computer processors (processing units), microprocessors, digital signal processors, controllers and microcontrollers, etc. Examples of device memories that may comprise logic include RAM (random access memory), flash memories, ROMS (read-only memories), EPROMS (erasable programmable read-only memories), and EEPROMS (electrically erasable programmable read-only memories). A transceiver includes but is not limited to cellular, GPRS, Bluetooth®, and Wi-Fi transceivers.

Mobile devices communicate with each other and with other elements via a network, for instance, a cellular network. A “network” can include broadband wide-area networks, local-area networks, and personal area networks. Communication across a network can be packet-based or use radio and frequency/amplitude modulations using appropriate analog-digital-analog converters and other elements. Examples of radio networks include GSM, CDMA, Wi-Fi and BLUETOOTH® networks, with communication being enabled by transceivers. A network typically includes a plurality of elements such as servers that host logic for performing tasks on the network. Servers may be placed at several logical points on the network. Servers may further be in communication with databases and can enable communication devices to access the contents of a database. For instance, an authentication server hosts or is in communication with a database having authentication information for users of a mobile network. A “user account” may include several attributes for a particular user, including a unique identifier of the mobile device(s) owned by the user, relationships with other users, call data records, bank account information, etc. A billing server may host a user account for the user to which value is added or removed based on the user's usage of services. One of these services includes mobile payment. In exemplary mobile payment systems, a user account hosted at a billing server is debited or credited based upon transactions performed by a user using their mobile device as a payment method.

For the following description, it can be assumed that most correspondingly labeled elements across the figures (e.g., 207 and 307, etc.) possess the same characteristics and are subject to the same structure and function. If there is a difference between correspondingly labeled elements that is not pointed out, and this difference results in a non-corresponding structure or function of an element for a particular embodiment, then that conflicting description given for that particular embodiment shall govern.

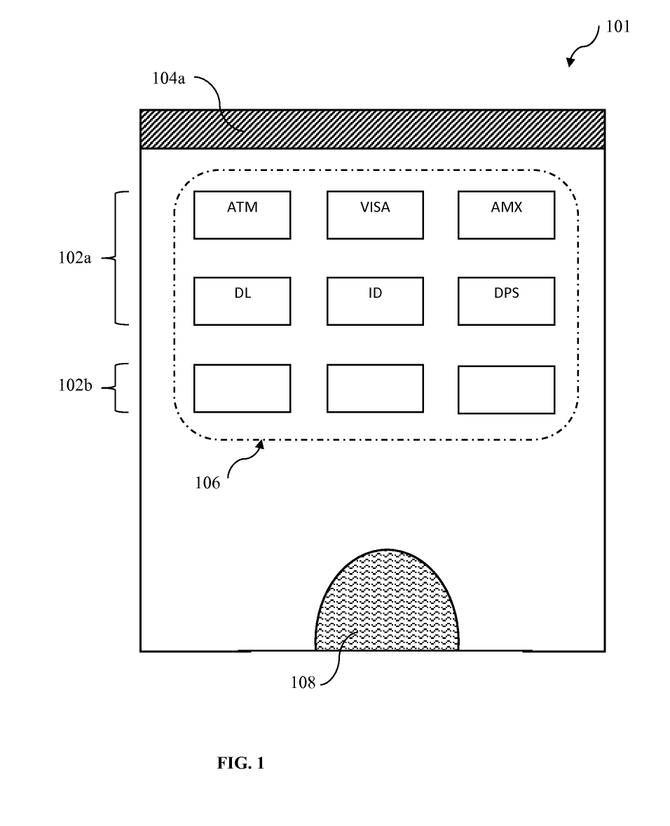

FIG. 1 is a schematic view of an exemplary digital card device, according to an embodiment. The digital card device 101 is a device that is configured to replace the plastic cards currently used as debit/credit cards, ID cards, and the like. The digital card device 101 may have a memory, a transmitter or a transceiver, an input, an output and a processor. The memory stores data, applications, software, or logic. One application, called herein the digital card app is configured to, for example, enable a user to store in the digital card device 101 all of the data associated with her cards and then carry and use the digital card device 101 instead of the cards to achieve the same results as with the cards, such as making an electronic payment or identifying herself. The exact configuration and structural elements of the digital card device 101 may vary as necessary to accomplish the various functionalities of the digital card device 101 as described hereinafter.

The digital card device 101 may store the data associated with all of a user's cards so that she would not need to carry with her any cards. As shown in FIG. 1, 102a-102b, the user may replace her ATM card(s), credit card(s) (e.g., VISA), her driver license (DL) or ID card, department store (DPS) card(s) and so on. Other cards that the user may replace by using the digital card device 101 may be an access card, such for work, parking, and so on.

The data associated with each card may be installed into the digital card device 101 using various approaches. For example, the data for a debit/ATM card could be uploaded into the digital card device 101 from the bank's computer system when the user visits a local branch of the bank. Similarly, the user's driver license data could be uploaded by the local DMV office. As another example, the data could be uploaded/downloaded securely over the internet.

The data associated with each card may be the same as the data associated with current plastic cards. For example, if the replaced card is a credit card, the data may include the person's name, the credit card number, the valid thru date, the card's security code and/or the data contained by the card's magnetic strip, such that, again, the user can authorize an electronic payment using the digital card device 101 instead of the actual plastic credit card.

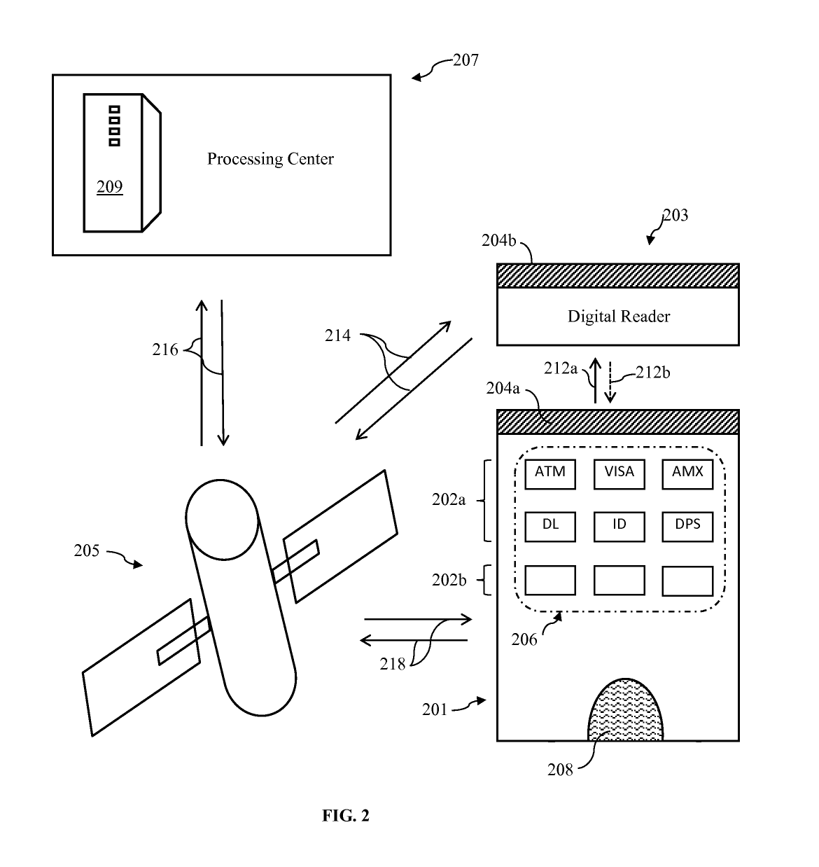

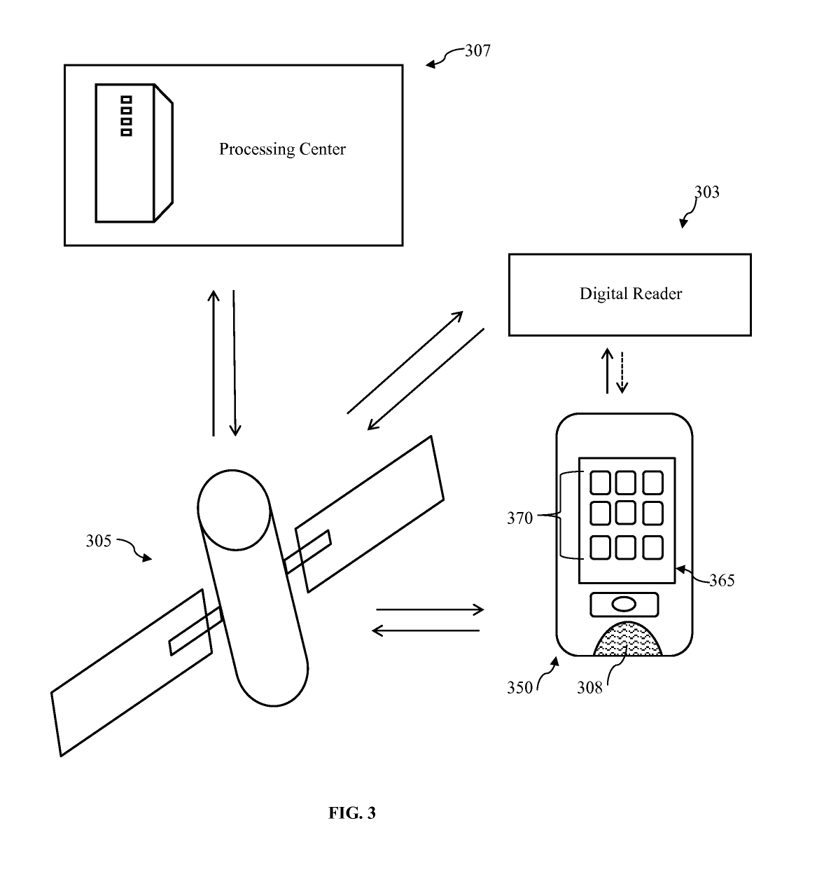

As shown in FIG. 1, each card may have a button or switch 102a-b associated with it. The buttons may be of a mechanical type, or, preferably, they may be touchscreen buttons/switches on a screen/display 106 such as the icons on a smartphone display that launch various applications installed into the smartphone. The buttons 102a-b may be configured to, for example, actuate the transmission of the data of the respective card (e.g., a credit card) to a digital reader (see 203 in FIG. 2) for the purpose of performing a transaction (e.g., pay for the goods purchased at a store), as it will explained in more details later herein when referring to FIGS. 2-3. As one exemplary alternative, the buttons 102a-b may launch the digital card app for accessing other functions of the app for that particular card, such as editing the name of the card.

The digital card device 101 may have a fingerprint scanner 108 for increasing the security of the transactions conducted with the device. For example, the digital card device 101 may be configured to be operational only after the user scans her fingerprint and the fingerprint is recognized by the device. This very important for situations, when, for example the digital card device 101 is lost. The fingerprint feature may prevent the unauthorized use of the device, and thus, the unauthorized access to owner's funds, identity, etc. Concomitantly or alternatively, a personal password may also be used to identify the proper owner of the digital card device 101. Such a password may be inputted using, for example, a touchscreen keyboard (not shown), which may be made available to user on the display 106.

The digital card device 101 may communicate with a digital reader (203 in FIG. 2) using a communication element 104a. The communication element 104a may be contactless or contact based. A contactless communication element 104a may include, for example, a transceiver, and the contactless communication may use Bluetooth® technology. A contact based communication element 104a may use, for example, Bump technology, which allows two smartphone users to physically bump their phones together to transfer contact information, photos, and files to each other over the Internet; other similar technologies, now known or future developed, may be used which, for example, may transfer data directly from the digital card device 101 to the digital reader, without the need of the Internet. Thus, the digital card device may be configured to actuate transfer of card data to the digital reader by simply “bumping” the digital card device into the digital reader.

The digital reader (203 in FIG. 2) may be a replacement or a modification of the Point-of-Sale (POS) card reader currently used in stores, gas stations, banks, restaurants and so on. The digital reader may also be installed in police cars for identification of a driver by a policeman, at the DMV, at the entrance of various buildings or parking lots to control access, on computers to restrict access to them, and so on.

The digital card device 101 may be programmed to keep in its memory the history of any transaction, balances, credit available, and/or other data, so as to be available to user all the time. Alternatively, the digital card device 101 may be configured to access a database through the processing center 207 (FIG. 2) for retrieving such data.

FIG. 2 is a schematic view of an exemplary system incorporating the digital card device from FIG. 1, according to several embodiments. Again, as indicated above, each of the buttons 202a-b may be associated with the data of a certain card, such as an ATM/debit card. Thus, for example, when the user is at a store and wants to pay for what she wishes to buy, she would typically simply press or touch the ATM button to initiate the payment transaction. The fingerprint may need to be scanned using scanner 208, and/or a password entered, before or after pressing/touching the ATM button in order to authorize the transaction.

Next, the data needed to process the payment will be transferred to the digital reader 203, via transfer link 212a, for example wirelessly using the communication element 204a (e.g., a transceiver); the digital reader 203 will receive the data using its corresponding communication element 204b (e.g., also a transceiver). Next, typically, the digital reader 203 will transmit the digital card data to a processing center 207 for verification and approval of the charge to the account associated with the ATM digital card.

Once the processing center 207 approves the charge, the transaction is complete and the processing center 207 may send a confirmation message to the digital reader 203 and/or the digital card device 201. The digital reader 203 may also be configured to send information to the digital card device 201 via link 212b. Such information may include a copy of the receipt.

The processing center may include one or more servers 209, applications and databases (not shown) necessary to process the payment transaction. The communication between the digital reader 203 and the processing center 207 may occur through the Internet, a cellular network, a satellite 205 communication network or the like, via the two-way communication links 214 and 216. Similarly, the digital card device 201 may communicate with the processing center 207 via communication link 218, for, for example, accessing the account balance, or the like.

FIG. 3 is a schematic view of an alternative exemplary system incorporating a mobile device 350 adapted to function as a digital card device, according to several embodiments. It may be preferred to integrate the entire functionality of the digital card device described above into a mobile device, and particularly, into a smartphone. This is because, for example, a smartphone (350 in FIG. 3) already has all the hardware (memory, processor, touchscreen display 365, etc) necessary to support the functionality of the digital card device described above. They also already have the ability to communicate with the processing center 307 via a cellular network and/or the Internet 305 and with the digital reader 303 via technologies such as Bluetooth or the Bump technology. Thus, a simple upload/download by the manufacturer of the smartphone or by the owner/user of the smartphone of the specific application, the digital card app, would enable the smartphone to also function as a digital card device. This would eliminate the inconvenience for a person to routinely carry two devices, the digital card device and the smartphone (or another mobile device). Given the increased ubiquitousness of the smartphones and the appeal to smartphone users for using the smartphone for “everything,” this approach is preferred.

Again, many smartphones already have a touchscreen display 356 for input or output of data (or at least a physical keyboard and a display). Once the digital card app, which enables all the functionality of the digital card described above, is installed into the smartphone 350, the user may, for example, after launching the digital card app, see on the display 365 all the digital cards (e.g., ATM, VISA, Driver License (DL), etc) already installed or available for installation by, for example, visiting the respective institution's secure website (bank, DMV, etc). Again, each icon or button 370 will be associated with one digital card. Actuating of an icon or button, such as by touching or pressing it, may initiate a digital transaction as described earlier.

For increased security, again, the user may be asked to enter a password before the transaction may initiate. This functionality is also already supported by existing smartphone. Given the great sensitivity of the data and of the transactions enabled by the digital card app (i.e., financial data, personal data, etc), the smartphone used as a digital card device may need to have a fingerprint scanner 308 to prevent unauthorized use of the device, such as in case of loss, as explained earlier.

Thus, in one exemplary embodiment, the digital card app may be an application programmed to enable a mobile device such as a smartphone to do the following, in any order: receive data about and/or data embedded in cards such as a credit card or an ID card; store that data; authenticate the user of the mobile device and of the digital card app by for example requiring a password and/or a fingerprint scan; upon user's command(s) (e.g., by touching an icon or a link on a touchscreen) transmitting, preferably in an encrypted way, the card data necessary to effectuate a transaction (e.g., pay for goods or services) to a digital reader. Additionally, as an example, the digital card app may enable the mobile device to communicate with a processing center for, for example, retrieving account balances or authorizing the transaction. Thus, the need to carry and use any physical (e.g., made from plastic) cards (e.g., debit/credit cards, ID cards, parking access cards, etc) may be completely eliminated, and a user may use instead her mobile device (e.g., a smart phone) to perform all transactions digitally/electronically, as described hereinbefore, without possessing or using a plastic card or other type of physical card (i.e., cardless transactions). Furthermore, the need for card issuers to manufacture physical cards may be also completely eliminated, as they will simply need to transfer the card data necessary to effectuate cardless transactions directly to their customers' mobile devices (e.g., a smartphone).

It should be noted that occasionally, a transaction may take place exclusively offline, just between the digital card device 201 (or, alternatively, smartphone 350) and the digital reader 203 (or 303), such as, for example, for gaining access to a parking structure. The digital reader at the entrance of the parking structure may only need a code from the smartphone, which the reader may check against an internal database, to allow entry.

The communication between the digital card device or smartphone and the card reader may be accomplished by, for example, using ten different light colors such that each represents a number from 0-9. For example, red could represent 0 and blue could represent #1 and so on. Each customer may then be assigned to about fifty combinations of these lights that will be received by the card reader and that may be sent to the processing center via a network.

Another feature that the digital card device or the smartphone may need to have is a small battery supply or small solar battery so that in case the main battery runs out of power, the smaller battery could take over. Another way the device could be recharged is by being shaken vigorously.

Because this device will typically be used also as ID card, it needs to be carried by its' owner all the times. In order for this to occur securely, the device may be sensitive to body heat and if it is moved too far from the owner, for example for more than five feet, an alarm would go off.

It may be advantageous to set forth additional definitions of certain words and phrases used in this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Throughout this description, the embodiments and examples shown should be considered as exemplars, rather than limitations on the apparatus and procedures disclosed or claimed. Although many of the examples involve specific combinations of method acts or system elements, it should be understood that those acts and those elements may be combined in other ways to accomplish the same objectives.

With regard to disclosed processes, additional and fewer steps may be taken, and the steps as described may be combined or further refined to achieve the described methods. Acts, elements and features discussed only in connection with one embodiment are not intended to be excluded from a similar role in other embodiments.

One or more embodiments of the invention may be described as a process. Although the description may be of a sequential process, many of the operations can be performed in parallel or concurrently. In addition, the order of the operations may be re-arranged. A process is terminated when its operations are completed. A process may correspond to a method, a program, a procedure, etc.

Although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the invention. Therefore, the scope of this application is intended to cover alternate embodiments and/or equivalent variations of the specific embodiments illustrated and/or described herein. Hence, the scope of the invention is defined by the accompanying claims and their equivalents. Furthermore, each and every claim is incorporated as further disclosure into the specification and the claims are embodiment(s) of the invention.

1. A mobile device configured to replace at least one physical card of a user, the mobile device being capable of performing a process comprising in any order the steps of:
receiving from the card issuer card data necessary for performing cardless transactions;
storing the card data; receiving from the user instructions for initiating a cardless transaction; authenticating the user before the cardless transaction is initiated; and,
initiating the cardless transaction by transmitting the card data to a card data reader.

2. The mobile device from claim 1, wherein the mobile device is a smartphone.

3. The mobile device from claim 2, wherein the at least one physical card is a member of a group consisting of a debit card, a credit card, an ID card, a driver license, a building access card and a department store card.

4. The mobile device from claim 2, wherein the smartphone is sensitive to body heat so that if the smartphone is moved a predetermined distance away from its owner, an alarm goes off.

5. The mobile device from claim 2, wherein the cardless transaction is an electronic payment and the card data reader is a point-of-sale card reader.

6. The mobile device from claim 1, wherein the process is enabled by a digital card application installed in the mobile device.

7. The mobile device from claim 1, wherein the authentication of the user is accomplished using a fingerprint scanner integrated in the mobile device.

8. The mobile device from claim 1, wherein the transmission of the card data to the card data reader is contactless.

9. The mobile device from claim 1, wherein the process further comprises communicating with a processing center over a mobile network.

10. A process for performing cardless transactions comprising in any order the steps of:
receiving from the card issuer card data necessary for performing cardless transactions;
storing the card data; receiving from the user instructions for initiating a cardless transaction; authenticating the user before the cardless transaction is initiated; and, initiating the cardless transaction by transmitting the card data to a card data reader.

11. The process from claim 10, wherein the card issuer is a financial institution.

12. The process from claim 10, wherein the process is enabled by a digital card application installed in the mobile device.

13. The process from claim 12, wherein the initiation of the cardless transaction is performed by a user by touching a card icon on a touchscreen of a smartphone.

14. The process from claim 10, wherein the cardless transaction is an electronic payment and the card data reader is a point-of-sale card reader.

15. The process from claim 10, wherein the authentication of the user is accomplished using a fingerprint scanner integrated in a mobile device.

16. The process from claim 10, wherein the transmission of the card data to the card data reader is contactless.

17. The process from claim 10, further comprising communicating with a processing center over a mobile network and requesting approval of the cardless transaction by the processing center.

18. A digital card device configured to replace at least one physical card of a user, the digital card device being capable of performing a process comprising in any order the steps of:
receiving from the card issuer card data necessary for performing cardless transactions;
storing the card data; receiving from the user instructions for initiating a cardless transaction; authenticating the user before the cardless transaction is initiated; and,
initiating the cardless transaction by transmitting the card data to a card data reader.

19. The digital card device of claim 18, wherein the authentication of the user is accomplished using a fingerprint scanner integrated in the digital card device.

20. The digital card device of claim 18, wherein the transmission of the card data to the card data reader is contactless.
